(19) United States
(12) Patent Application Publication
(10) Pub. No.: US 2017/0084984 A1
(43) Pub. Date: Mar. 23, 2017

(54) Booster Antenna

(71) Applicant: Tabletop Media LLC d/b/a Ziosk, Dallas, TX (US)

(72) Inventors: John KAJANDER, Garland, TX (US); Viren R. BALAR, Allen, TX (US)

(73) Assignee: Tabletop Media LLC d/b/a Ziosk, Dallas, TX (US)

(21) Appl. No.: 15/272,330

(22) Filed: Sep. 21, 2016

Related U.S. Application Data
(60) Provisional application No. 62/222,152, filed on Sep. 22, 2015.

(51) Int. Cl. H01Q 1/24; H01Q 1/50; H01Q 7/06

(52) U.S. Cl. CPC H01Q 1/242; H01Q 7/06; H01Q 1/50

(57) ABSTRACT

A user terminal comprising: i) a housing; ii) a main radio frequency (RF) antenna disposed within an interior of the housing; and iii) a boost antenna mounted on an exterior of the housing and in close proximity to the main RF antenna. The first antenna segment of the boost antenna is configured to be magnetically coupled to the main RF antenna and a second antenna segment of the boost antenna is configured to be magnetically coupled to an antenna of a wireless device disposed close to the housing. The first antenna segment magnetically couples to RF signals transmitted to and received from the main RF antenna in a first direction. The second antenna segment magnetically couples to RF signals transmitted to and received from the RF antenna of the wireless device in a second direction. The first direction and the second direction are substantially orthogonal to each other.

### CROSS-REFERENCE TO RELATED APPLICATION(S) AND CLAIM OF PRIORITY

The present application is related to U.S. Provisional Patent No. 62/222,152, filed Sep. 22, 2015, entitled “BOOSTER ANTENNA”. Provisional Patent No. 62/222,152 is assigned to the assignee of the present application and is hereby incorporated by reference into the present application as if fully set forth herein. The present application hereby claims priority under 35 U.S.C. §119(e) to U.S. Provisional Patent No. 62/222,152.

### TECHNICAL FIELD

The present application relates generally to wireless communication devices and, more specifically, to a boost antenna for attachment to a wireless terminal device.

### BACKGROUND

Near-field communication (NFC) refers to a set of communication protocols that enables two devices, one of which is typically a portable device (e.g., a smartphone), to establish wireless communication by bringing the devices within a very short distance (e.g., 2 inches or less) of each other. Near-field communication (NFC) devices are widely used in commerce. Typical applications include payment terminals that use an NFC transceiver to communicate bi-directionally with a wireless phone or other hand-held device in order to allow the operator of the hand-held device to make a purchase using, for example, any information related to an NFC enabled payment, debit card, credit card, gift card, loyalty card, membership card, e-club pass, mobile pass, coupon, any other payment related or consumer identification, health or preference related information, or any combination thereof stored on the hand-held device.

Many compact-sized payment terminals were designed with thin smartphones in mind. For example, some user terminals may have a base (or platform or pedestal) that supports a display screen in an elevated position. The base of the terminal may contain an NFC transceiver and the screen may be only an inch or two above the base. However, this short gap was generally not a problem, because most smartphones with an NFC transceiver are thin devices. A user could therefore slip the smartphone easily within the gap to allow the smartphone NFC transceiver to communicate with the NFC transceiver in the base of the terminal.

However, as more and more information appliances incorporate near-field communication technology, many user terminals are proving not to be ergonomically suitable for some applications. By way of example, NFC transceivers are now being implemented in a variety of smart wearables including smartwatches. But the combined thickness of the wrist of the user and the smartwatch may be several inches and would not fit within a narrow gap. To bring a smartwatch close to the NFC transceiver, the user typically must remove the smartwatch and place it on the part of the user terminal where the NFC transceiver is located. Obviously, this would be annoying to the user.

Therefore, there is a need in the art for apparatuses and methods that improve communications with NFC transceivers in user terminals.

### SUMMARY

To address the above-discussed deficiencies of the prior art, it is a primary object to provide a user terminal comprising: i) a housing; ii) a main radio frequency (RF) antenna disposed within an interior of the housing; and iii) a boost antenna mounted on an exterior of the housing and in close proximity to the main RF antenna. A first antenna segment of the boost antenna is configured to be magnetically coupled to the main RF antenna and a second antenna segment of the boost antenna is configured to be magnetically coupled to an antenna of a wireless device disposed close to the housing.

In one embodiment, the first antenna segment magnetically couples to RF signals transmitted to and received from the main RF antenna in a first direction.

In another embodiment, the second antenna segment magnetically couples to RF signals transmitted to and received from the RF antenna of the wireless device in a second direction.

In still another embodiment, the first direction and the second direction are spaced apart by at least 45 degrees.

In yet another embodiment, the first direction and the second direction are substantially orthogonal to each other.

In a further embodiment, the first antenna segment is disposed on a first surface of the housing and the second antenna segment is disposed on a second surface of the housing.

In a still further embodiment, the first surface of the housing and the second surface of the housing are spaced apart by at least 45 degrees.

In a yet further embodiment, the first surface of the housing and the second surface of the housing are substantially orthogonal to each other.

In one embodiment, the boost antenna is removably attached to the exterior of the housing.

In another embodiment, the boost antenna is flexible such that an angle between the first antenna segment and the second antenna segment may be adjusted.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a perspective view of an exemplary portable user interface terminal according to one embodiment of the disclosure.

FIG. 2 is a cross-sectional view of the base and boost antenna of the user interface terminal according to one embodiment of the disclosure.

FIG. 3 is a schematic layout of the main antenna, the boost antenna, and an antenna in a user watch according to one embodiment of the disclosure.

### DETAILED DESCRIPTION

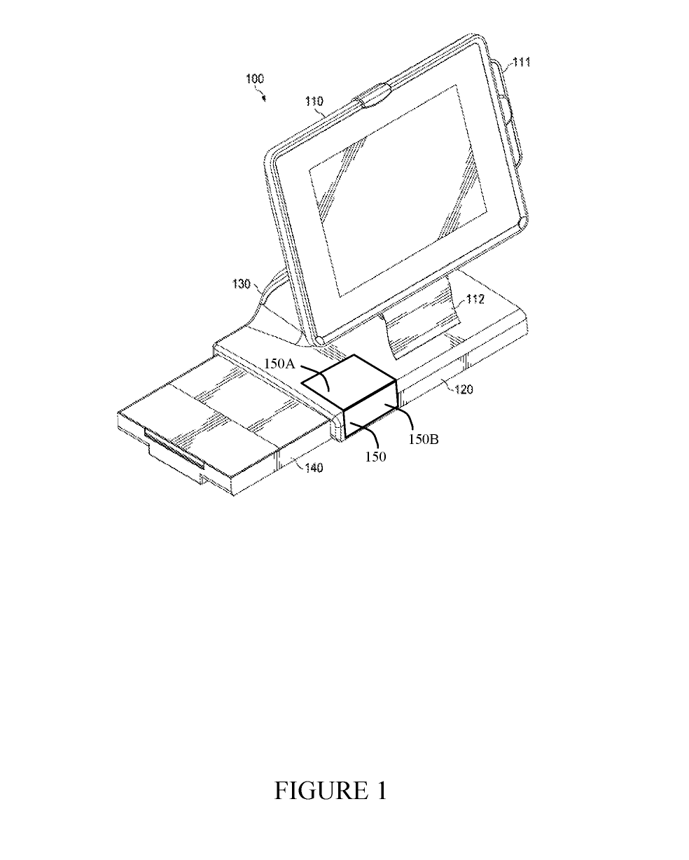

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless device.

FIG. 1 is a perspective view of exemplary portable user interface terminal 100 in accordance with one embodiment of the disclosure. Portable user interface terminal 100 comprises display module 110, base 120, support 130, removable battery pack 140, and boost antenna 150. For ease of explanation, battery pack 140 is shown partially removed from base 120. Base 120 is a housing or protective shell that is typically placed on a countertop or a tabletop and support 130 holds display module 110 in an elevated position with the display screen inclined toward the customer to make viewing easy. In some embodiments, display module 110 may comprise credit card swipe device 111 and an internal thermal printer (not shown) that prints receipt 112 for a customer.

In an advantageous embodiment of the disclosure, battery pack 140 comprises a smart card reader and an internal NFC antenna (not shown) and NFC transceiver (not shown). When battery pack 140 is fully inserted into base 120, the external end of battery pack 140 is substantially flush with the end of base 120. The smart card reader may be disposed near the external end of battery pack 140, so that when battery pack 140 is fully inserted into base 120, an EMV card (i.e., smart card) may be easily inserted into the smart card reader for payment purposes. Also, the internal NFC antenna may be disposed adjacent an upper surface of battery pack 140, so that when battery pack 140 is inserted into base 120, the internal NFC antenna is faced upwards just inside the shell of base 120. In such an arrangement, another NFC-capable device (e.g., a smart wearable, smartphone or smart watch with an NFC antenna and transceiver) that is brought within a few inches of the upper surface of base 120 may communicate with the internal NFC antenna and internal NFC transceiver of battery pack 140. The communication may include information for an NFC enabled payment, debit card, credit card, store value card, gift card, loyalty card, membership card, e-club pass, mobile pass, coupon, any other payment related or consumer identification, health or preference related information, or any combination thereof

However, due to the location of the internal NFC antenna below display module 110, it may be awkward for a user to place a smartphone, a wrist-worn smartwatch or other smart wearable close enough to the internal NFC antenna. Therefore, to improve the usability and coupling between the external NFC-capable device (or any other small antenna device) and the internal NFC antenna in base 120, boost antenna 150 is mounted on the exterior of base 120 in close proximity to the internal NFC antenna. In FIG. 1, first antenna segment 150A of boost antenna 150 is disposed on the top surface of base 120 and second antenna segment 150B of boost antenna 150 is disposed on the front surface of base 120, since the internal NFC antenna is located just inside base 120 at that approximate location. Boost antenna 150 loop is bent approximately in half at a right angle (90 degrees) to form an L-shaped loop.

Generally, antenna segments 150A and 150B of boost antenna 150 propagate RF signals in two different directions, which may be orthogonal to each other. Thus, in an advantageous implementation, antenna segment 150A may transmit and receive RF signals to and from the internal NFC transceiver in a vertical direction (i.e., perpendicular to the top surface of base 120) and antenna segment 150B may transmit and receive RF signals to and from the internal NFC transceiver in a horizontal direction (i.e., perpendicular to the front surface of base 120).

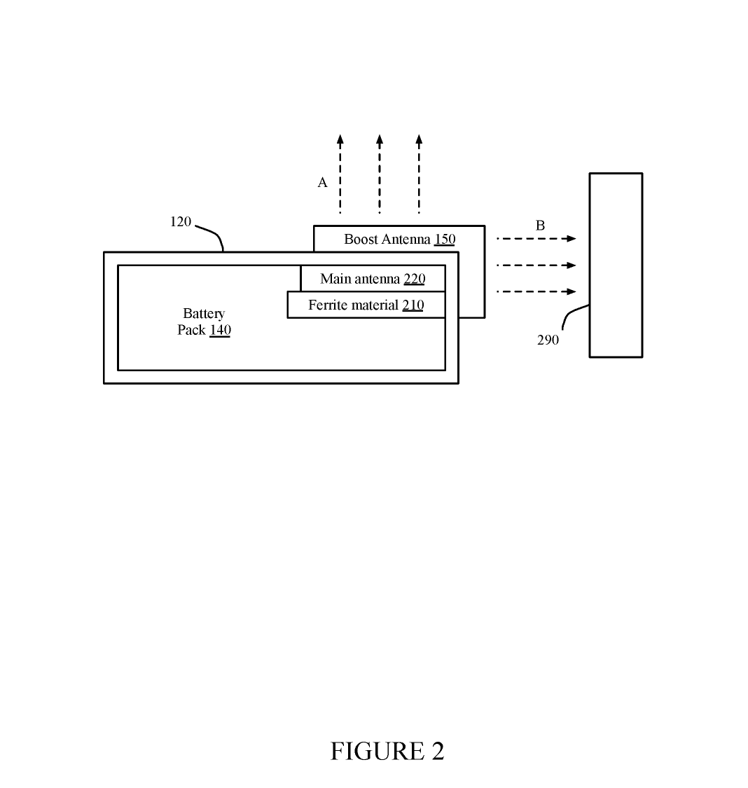

FIG. 2 is a cross-sectional view of base 120 and boost antenna 150. Battery pack 140 is shown disposed within base 120. Main antenna 220 (i.e., NFC antenna) is mounted near the upper surface of battery pack 140 and propagates signals upward (i.e., in direction A) through the top surface of base 120. Ferrite material 210 separates main antenna 220 from other components in battery pack 140, including the internal NFC transceiver. Boost antenna 150 is mounted on the top surface and front surface of base 120 in close proximity to main antenna 220 inside of base 120.

In one embodiment, boost antenna 150 may be implemented as an add-on sticker, label or coating comprising an antenna booster, an NFC logo, and a watch logo. The logos indicate to the user the approximate target locations for communicating with such items as credit cards, smart phones, and smart watches. In one embodiment, boost antenna 150 may be implemented as a passive device, such as conductive ink traces or metal traces, similar to an RF ID tag antenna but without a microchip or power storage. Passive devices are advantageous for multiple of reasons including low power usage. In another embodiment, boost antenna 150 may be embedded on or within the housing of portable user interface terminal 100, battery pack 140 or any other housing proximate to portable user interface terminal 100. In still another embodiment, boost antenna 150 may be included in, embedded as or a part of the metallic traces comprising display module 110. For example, display module 110 may include boost antenna 150 embedded as or a part of the metallic traces of a liquid-crystal display (LCD) or panel. In yet another embodiment, boost antenna 150 may be implemented as an active device with a microchip and power storage that transmits a modified signal. Boost antenna 150 may be attached to base 120 temporarily (e.g., Velcro attachment) or permanently (e.g., strong adhesive)

In the example shown in FIG. 2, boost antenna 150 communicates with an NFC transceiver (not shown) in smartwatch 290. Smartwatch 290 may be or include any smart phone, smart tablet, smart watch, smart jewelry, smart clothing, smart glove, smart accessory, biometric, bio-sensing, implanted, transdermal, wearable, or payment or identification device, capability, technology, or any combination thereof. In addition, Smartwatch 290 may provide a profile or information on health, fitness, medical, diet, nutrition or allergy information, restaurant or brand loyalty or e-club information, mobile passes, e-club, coupons, customer food, beverage, environment or entertainment preferences or dispositions of a person or entity related to or associated with Smartwatch 290, or any combination thereof.

This design uses boost antenna 150 to capture energy from main antenna 220 and the novel design bends the magnetic field approximately 90 degrees for wrist-mounted smartwatch applications and other applications. Boost antenna 150, when mounted directly above the main antenna 220, is magnetically coupled to main antenna 220. In an exemplary embodiment, boost antenna 150 comprises a magnetic circuit inductor (L1) and a tuning capacitor (C1) tuned to 13.56 MHz.

The design of boost antenna 150 allows radio frequency (RF) power to be transferred at a right angle (90 degrees) to the main magnetic field. Thus, in FIG. 2, boost antenna segment 150A transmits and receives in direction A (i.e., vertically) through the top surface of base 120 and boost antenna segment 150B transmits and receives in direction B (i.e., horizontally) through the front surface of base 120. Boost antenna 150 may have a watch logo located at its magnetic center. When a small device, such as smartwatch 290, is brought in close proximity to the watch target logo, it will become magnetically coupled to main antenna 220, via boost antenna 150, thereby allowing a point-of-sale (POS) transaction to take place. Furthermore, boost antenna 150 allows for better coupling and usability with smaller antenna devices.

A wrist-mounted smartwatch 290 may be too big to fit in the gap between the bottom of display module 110 and the top surface of base 120. Alternatively, smartwatch 290 may be at right angle to the magnetic field (direction A) of main antenna 220, which would provide no magnetic coupling to main antenna 220. In either case, without boost antenna 150, smartwatch 290 may not be able to communicate with main antenna 220 and no POS transaction would occur. A user would have to remove smartwatch 290 from his or her wrist and place smartwatch 290 on the main target logo for a POS transaction.

Boost antenna segment 150B on the front surface of base 120 would allow the user's arm and smartwatch 290 to be placed parallel to boost antenna segment 150B thereby maximizing coupling for a successful POS transaction. The POS transaction between smartwatch 290 and NFC reader main antenna 220 via the boost antenna 150 comprises a two-way communications link. A successful POS transaction is dependent on good magnetic coupling between smartwatch 290 and boost antenna 150. This is accomplished only when smartwatch 290 antenna and boost antenna 150 are parallel to each other and in close proximity to each other.

As the antenna of smartwatch 290 detects the incoming magnetic field from boost antenna 150, smartwatch 290 turns ON and responds, in accordance with ISO 1-4443 protocols, by sending data via the magnetic field of smartwatch 290. The magnetic field of smartwatch 290 couples into boost antenna 150 altering its current, which in turn, alters the current in main antenna 220 of the NFC transceiver (not shown) in battery pack 140. The POS reader electronics of terminal 100 detects the change in main antenna 220 current as data.

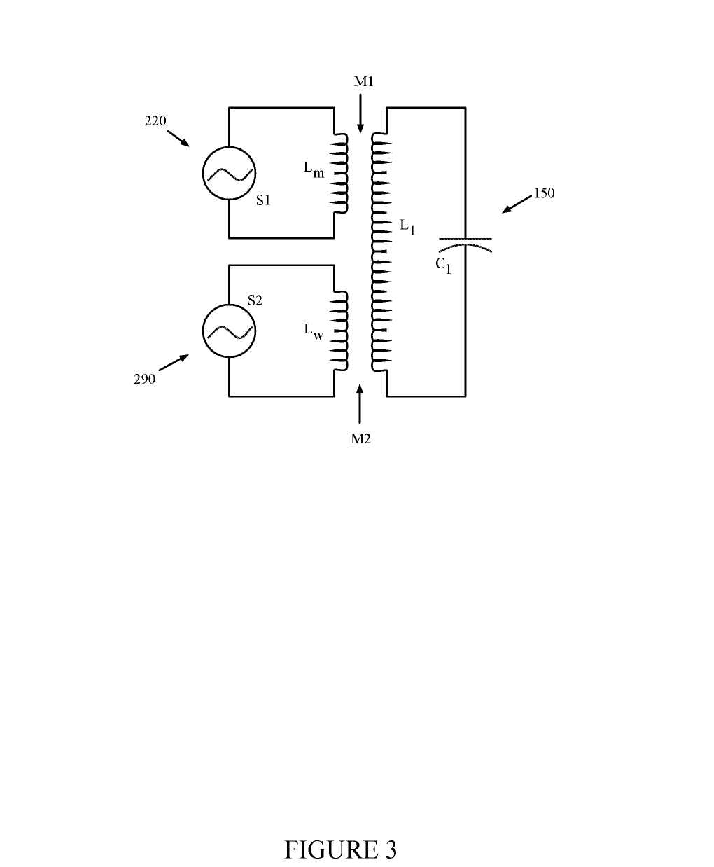

FIG. 3 is a schematic layout of main antenna 220, boost antenna 150, and the antenna in smartwatch 290. In FIG. 3, NFC signal source Si in battery pack 140 drives main antenna 150, which is represented by inductance L. Boost antenna 150 is represented by inductance L₁, and tuning capacitor C₁. NFC signal source S2 in smartwatch 290 drives a watch antenna, represented by inductance L_{w}. M1 is the mutual magnetic field coupling between main antenna 220 and boost antenna 150. M2 is the mutual magnetic field coupling between boost antenna 150 and the antenna in smartwatch 290. Tuning capacitor, C₁, may be a parallel plate-type capacitor. Boost antenna 150 may be fabricated on a flexible printed circuit material.

In an exemplary embodiment, main antenna 220, boost antenna 150, and the antenna in smartwatch 290 are all tuned to 13.56 MHz. Thus, for boost antenna 150, inductor L₁ and capacitor C₁ are tuned to 13.56 MHz, and the frequency is given by:

$$fo = \frac{1}{2 π \sqrt{{( {L}_{1} )}^{*} {C}_{1}}} = 13.56 MHz .$$

In an alternate embodiment of the disclosure, boost antenna 150 may be mounted on the top surface and front surface of battery pack 140, rather than on the exterior surfaces of base 120. In such an embodiment, boost antenna segment 150A and boost antenna segment 150B transmit and receive RF signals through the shell of base 120. It will also be understood by those of ordinary skill in the art that direction A and direction B in FIG. 2 do not necessarily have to be orthogonal (perpendicular) to each other in order for boost antenna 150 to be effective. In another alternate embodiment of the disclosure, the front surface of base 120 may be sloped at a 45-degree angle or another angle. In such an embodiment, boost antenna segment 150A and boost antenna segment 150B will be oriented at 45 degrees (or another angle) with respect to each other.

Advantageously, boost antenna 150 enables existing wireless apparatuses similar to portable user interface terminal 100 that have already been deployed to be easily retrofitted to enhance the capabilities of the NFC reader or other wireless transceiver within the wireless apparatus. Boost antenna 150 may simply be mounted or attached to the exterior of any wireless apparatus near the internal antenna of the wireless apparatus in order to provide enhanced wireless communication in two substantially different directions.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A user terminal comprising:
a housing;
a main radio frequency (RF) antenna disposed within an interior of the housing; and
a boost antenna mounted on an exterior of the housing and in close proximity to the main RF antenna, wherein a first antenna segment of the boost antenna is configured to be magnetically coupled to the main RF antenna and a second antenna segment of the boost antenna is configured to be magnetically coupled to an antenna of a wireless device disposed close to the housing.

2. The user terminal as set forth in claim 1, wherein the first antenna segment magnetically couples to RF signals transmitted to and received from the main RF antenna in a first direction.

3. The user terminal as set forth in claim 2, wherein the second antenna segment magnetically couples to RF signals transmitted to and received from the antenna of the wireless device in a second direction.

4. The user terminal as set forth in claim 3, wherein the first direction and the second direction are spaced apart by at least 45 degrees.

5. The user terminal as set forth in claim 4, wherein the first direction and the second direction are substantially orthogonal to each other.

6. The user terminal as set forth in claim 1, wherein the first antenna segment is disposed on a first surface of the housing and the second antenna segment is disposed on a second surface of the housing.

7. The user terminal as set forth in claim 6, wherein the first surface of the housing and the second surface of the housing are spaced apart by at least 45 degrees.

8. The user terminal as set forth in claim 7, wherein the first surface of the housing and the second surface of the housing are substantially orthogonal to each other.

9. The user terminal as set forth in claim 1, wherein the boost antenna is removably attached to the exterior of the housing.

10. The user terminal as set forth in claim 1, wherein the boost antenna is flexible such that an angle between the first antenna segment and the second antenna segment may be adjusted.

11. A boost antenna for use with a wireless apparatus comprising a housing and a main radio frequency (RF) antenna disposed within the housing, the boost antenna comprising:
a first antenna segment configured to be magnetically coupled to the main RF antenna; and
a second antenna segment configured to be magnetically coupled to an antenna of a wireless device disposed close to the housing.

12. The boost antenna as set forth in claim 11, wherein the first antenna segment is disposed on a first surface of the housing and the second antenna segment is disposed on a second surface of the housing.

13. The boost antenna as set forth in claim 12, wherein the first surface of the housing and the second surface of the housing are spaced apart by at least 45 degrees.

14. The boost antenna as set forth in claim 13, wherein the first surface of the housing and the second surface of the housing are substantially orthogonal to each other.

15. The boost antenna as set forth in claim 11, wherein the boost antenna is removably attached to the exterior of the housing.

16. The boost antenna as set forth in claim 11, wherein the boost antenna is flexible such that an angle between the first antenna segment and the second antenna segment may be adjusted.

17. A user terminal comprising:
a housing;
a battery pack configured to be removably inserted within the housing, the battery pack including a main radio frequency (RF) antenna disposed within an interior of the battery pack; and
a boost antenna mounted on an exterior of the battery pack and in close proximity to the main RF antenna, wherein a first antenna segment of the boost antenna is configured to be magnetically coupled to the main RF antenna and a second antenna segment of the boost antenna is configured to be magnetically coupled to an antenna of a wireless device disposed close to the housing.

18. The user terminal as set forth in claim 17, wherein the first antenna segment magnetically couples to RF signals transmitted to and received from the main RF antenna in a first direction.

19. The user terminal as set forth in claim 18, wherein the second antenna segment magnetically couples to RF signals transmitted to and received from the RF antenna of the wireless device in a second direction.

20. The boost antenna as set forth in claim 17, wherein the first surface of the housing and the second surface of the housing are spaced apart by at least 45 degrees.
